(19) United States
(12) Patent Application Publication
(10) Pub. No.: US 2007/0250363 A1
(43) Pub. Date: Oct. 25, 2007

(54) Enumerating Events For A Client

(76) Inventors: James R. Boykin, Pflugerville, TX (US); Alberto Giammaria, Austin, TX (US); Brian J. Schlosser, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/279,264

(22) Filed: Apr. 11, 2006

(51) Int. Cl. G06F 9/46

(52) U.S. Cl. 705/8

(57) ABSTRACT

Methods, apparatus, and products are disclosed for enumerating events for a client by receiving from one or more clients a request for events occurring in a requested time period, wherein the requested time period has a begin time other than the current time, retrieving from an event provider the requested events occurring in the requested time period, and providing in response to the one or more clients one or more of the retrieved events.

### BACKGROUND OF THE INVENTION

1. Field of the Invention

The field of the invention is data processing, or, more specifically, methods, apparatus, and products for enumerating events for a client.

2. Description Of Related Art

Administering powerful computer systems requires robust system management solutions. System management solutions administer computer systems by obtaining information about the hardware and software components of a computing environment, the state of each of the components, and the relationships between components. Examples of information obtained by a system management solution may include discovery of networks, network paths, computers, operating systems, file systems, network cards, installed applications, application components, user transactions, statistics of usage, and so on.

Currently a variety of approaches exist to discover and retrieve information from a computing environment, and to make this information available to clients. One existing mechanism for discovering, retrieving, and exposing information from a computing environment is through the Common Information Model (‘CIM’) standard defined by the Distributed Management Task Force (‘DMTF’). CIM models the hardware and software components of a computing environment and the relationships between components using a CIM Schema. Information regarding a computing environment is made available in the CIM model through an object broker called a CIM Object Manager (‘CIMOM’).

To retrieve the desired information regarding the computing environment, CIM clients issue requests to a CIMOM. To provide the information regarding the computing environment a CIMOM models the computing environment using class definitions maintained in the CIMOM's data repository. A CIMOM may also maintain instances of the class definitions within the repository, but these instances are usually only for CIMOM configuration. Typically instances are provided by developing and registering provider plug-ins. In such cases when a CIM client requests information regarding the computing environment from the CIMOM, the CIMOM retrieves the requested information from the data repository if the request is for a class definition. When the request is for an instance of a class, however, a CIMOM typically retrieves the requested information from the appropriate provider.

When a CIM client desires to be notified of changes to the computing environment, the CIM client can subscribe to receive specific events that represent changes to the state or behavior of components in a computing environment. In CIM terminology, these events are referred to as ‘indications.’ The CIM itself defines indication types for creation, deletion, and modification of objects. A provider writer can also add new indication types pertinent to specific components for which the provider provides indications. For instance, a service state provider could include indications that are used to notify a CIM client when a service is started or stopped. The existing CIM architecture supports a provider that publishes these indications. This provider is termed an event provider or indication provider. The current indication provider interface described in the CIM architecture, however, only allows a CIM client to request and receive new indications that represent changes to the state or behavior of components in a computing environment after a CIM client makes a request.

### SUMMARY OF THE INVENTION

Methods, apparatus, and products are disclosed for enumerating events for a client by receiving from one or more clients a request for events occurring in a requested time period, wherein the requested time period has a begin time other than the current time, retrieving from an event provider the requested events occurring in the requested time period, and providing in response to the one or more clients one or more of the retrieved events.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for enumerating events for a client according to embodiments of the present invention.

FIG. 2 sets forth a block diagram of automated computing machinery comprising an exemplary computer useful in enumerating events for a client according to embodiments of the present invention.

FIG. 3 sets forth a flow chart illustrating an exemplary method for enumerating events for a client according to embodiments of the present invention.

FIG. 4 sets forth a flow chart illustrating another exemplary method for enumerating events for a client according to embodiments of the present invention.

FIG. 5 sets forth a flow chart illustrating another exemplary method for enumerating events for a client according to embodiments of the present invention.

FIG. 6 sets forth a flow chart illustrating another exemplary method for enumerating events for a client according to embodiments of the present invention.

### DETAILED DESCRIPTION OF EXEMPLARY EMBODIMENTS

### DETAILED DESCRIPTION

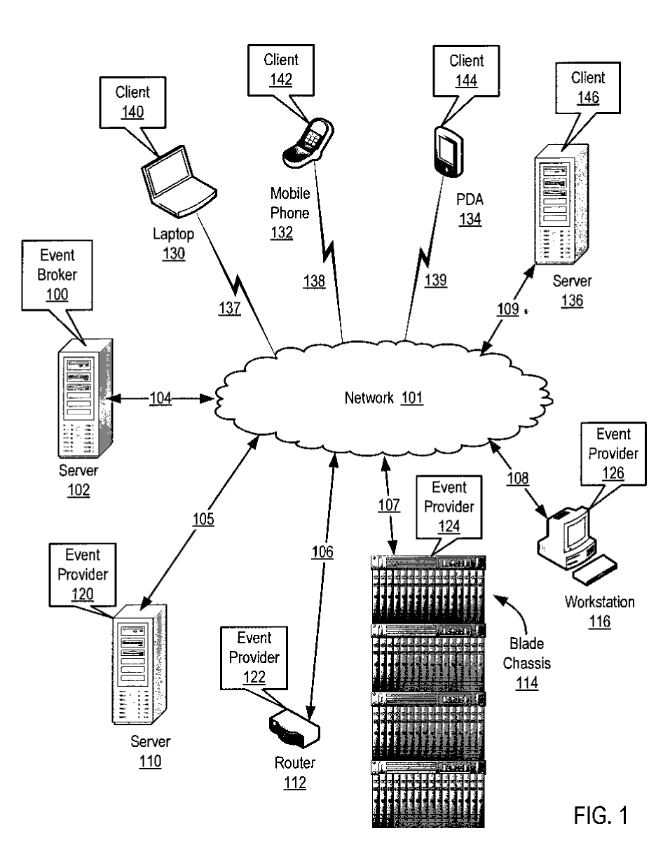

Exemplary methods, apparatus, and products for enumerating events for a client according to embodiments of the present invention are described with reference to the accompanying drawings, beginning with FIG. 1. FIG. 1 sets forth a network diagram illustrating an exemplary system for enumerating events for a client according to embodiments of the present invention. The system of FIG. 1 operates generally for enumerating events for a client according to embodiments of the present invention by receiving from one or more clients a request for events occurring in a requested time period, retrieving from an event provider the requested events occurring in the requested time period, and providing in response to the one or more clients one or more of the retrieved events.

An event represents a change in the state of a computing environment or in the behavior of some component of the computing environment. For example, an event may represent a change in the state of a software application service from ‘stopped’ to ‘started,’ a change in the physical configuration of a computer system when a plug and play adapter is added to the system, a change in data stored in computer memory, a change in the condition of a hardware component when a component failure occurs, and so on. An event may represent a change in the state of a computing environment that occurs infrequently such as, for example, a system reboot. An event may also represent frequently occurring changes such as, for example, a user clicking a mouse button or pressing a key of a keyboard.

In addition to the variation in frequency of an event, the manner in which a client handles an event may also vary. Some events may require immediate action on the part of a client. Consider, for example, a client that manages the free disk space on a web server. An event that represents an allocation of the last 100 megabytes of disk space may require immediate action by the client to make more disk space available. Other events may only require action at some later time. Consider, for example, a client that generates billing records for a network service provider. An event that represents changes in customer bandwidth utilization may only require action during nightly billing reconciliation.

The exemplary system for enumerating events for a client of FIG. 1 includes a number of devices (110, 112, 114, and 116) having installed upon them event providers (120, 122, 124, and 126) for providing events to an event broker. Each event provider (120, 122, 124, and 126) includes a set of computer program instructions for providing to an event broker the events representing changes in the state of each device (110-116) or the behavior of some component of each device (110, 112, 114, and 1 16). For example, event provider (120) installed on server (110) may provide an event broker with events representing each time an operating system accesses a disk drive of the server (110). Event provider (122) installed on router (112) may provide an event broker with events representing changes in the bandwidth availability through the router (1 12). Event provider (124) installed on blade chassis (114) may provide an event broker with events representing each time a system administrator installs or removes a server blade in blade chassis (1 14). Event provider (126) installed on workstation (116) may provide an event broker with events representing installation and removal of software applications on workstation (116).

In the system of FIG. 1, each event provider (120, 122, 124, and 126) includes a set of computer program instructions improved for returning to an event broker events occurring in a requested time period that the event provider supports when the event broker requests events from one of the event providers (120, 122, 124, or 126). Each event provider (120, 122, 124, and 126) has access to events that represent a change in state or behavior of the computing environment occurring in the past. Each event provider (120, 122, 124, and 126) may store such historical events in a database or serialize the events for storage in a flat file. Some event providers may access the historical events using the inherent structure of the component for which the historical events represent a change in state or behavior. Consider, for example, an event provider that provides events representing file creation in a file system. Such an event provider need not actually store events to access the historical events because the event provider may identify information regarding each file creation such as, for example, the creation time, the namespace associated with the file, the attributes, and so on, from the data contained in the file system itself.

In the exemplary system of FIG. 1, each event provider (120, 122, 124, and 126) may identify events through an application programming interface (‘API’) for the hardware or software component. The component's API may be implemented as functions contained in a dynamically linked library (‘DLL’) available to the event provider at run time or implemented as functions contained in a statically linked library included in the event provider at compile time. The component's API may also be implemented as methods of a dynamically loaded Java class.

The example system of FIG. 1 also includes server (102) connected to network (101) through a wireline connection (104). The server (102) has installed upon it an event broker (100). The event broker (100) of FIG. 1 is a set of computer program instructions improved for enumerating events for a client according to embodiments of the present invention. The event broker (100) provides events to a client according to the request of the client. For example, a client may subscribe to receive events representing when the input of an uninterrupted power supply deviates from a particular range. Although FIG. 1 depicts event broker (100) installed on server (102) separate from event providers (120, 122, 124, 126) or clients (140, 142, 144, 146), such a depiction is for explanation and not for limitation. In fact, an event broker capable of enumerating events for a client according to embodiments of the present invention may be installed on the same device as an event provider or other devices.

In the exemplary system of FIG. 1, the event broker (100) operates generally for enumerating events for a client according to embodiments of the present invention by receiving from one or more clients a request for events occurring in a requested time period, retrieving from an event provider the requested events occurring in the requested time period, and providing in response to the one or more clients one or more of the retrieved events. Examples of event brokers that may be improved for enumerating events for a client according to embodiments of the present invention may include the Storage Networking Industry Association Open Source Java Common Information Model Object Manager (‘CIMOM’), The Open Group OpenPegasus Release 2.5, the Sun Microsystems Solaris Web-Base Enterprise Management (‘WBEM’) Services 2.5, or the Microsoft® Windows Management Instrumentation (‘WMI’) technology.

In the example system of FIG. 1, the event broker (100) may communicate with each event provider (120, 122, 124, and 126) through a provider interface API. The provider interface API may implement communications between an event broker (100) and any one of the event providers (120, 122, 124, or 126) by establishing a data communications connection between the event broker (100) and an event provider (120, 122, 124, or 126) using, for example, a data communication connection implemented with the Transmission Control Protocol (‘TCP’) and the Internet Protocol (‘IP’). Through the data communications connection, the provider interface API may communicate data by calling member methods of a CORBA object, member methods of remote objects using the Java Remote Method Invocation (‘RMI’) API, or other methods provided through the API.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls (‘RPC’), although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java Remote Method Invocation API is a Java application programming interface for performing remote procedural calls published by Sun Microsystems. The Java RMI API is an object-oriented way of making remote procedure calls between Java objects existing in separate Java Virtual Machines that typically run on separate computers. The Java RMI API uses a remote interface to describe remote objects that reside on the server. Remote interfaces are published in an RMI registry where Java clients can obtain a reference to the remote interface of a remote Java object. Using compiled ‘stubs’ for the client side and ‘skeletons’ on the server side to provide the network connection operations, the Java RMI allows a Java client to access a remote Java object just like any other local Java object.

The example system of FIG. 1 also includes a number of devices (130, 132, 134, and 136) having installed upon them clients (140, 142, 144, and 146). Each client (140, 142, 144, and 146) includes a set of computer program instructions for requesting events from an event broker (100) occurring in a requested time period. For example, a client (140, 142, 144, or 146) that monitors abnormal banking activity to alert customers of potential fraud may request events from an event broker (100) representing all the transactions for a particular bank account within the last four hours. For further example, a client (140, 142, 144, or 146) that supplies hardware drivers to operate hardware components may request events from an event broker (100) representing installation or removal of hardware components in a computer system since the previous request. Examples of clients useful in enumerating events for a client according to embodiments of the present invention may include the IBM®

Director or the Sun Microsystems Solaris™ Management Console.

In the example system of FIG. 1, each client (140, 142, 144, and 146) communicates with the event broker (100) using a client interface API. A client interface API may implement communications between a client (140, 142, 144, or 146) and the event broker (100) by establishing a data communications connection between a client (140, 142, 144, or 146) and the event broker (100) using, for example, a TCP/IP connection. Through the data communications connection, the client interface API may communicate data between a client (140, 142, 144, and 146) and the event broker (100) by calling member methods of a CORBA object or member methods of remote objects using the Java Remote Method Invocation (‘RMI’) API.

A client interface API may also pass requests and responses through the data communications connection between the client (140, 142, 144, or 146) and the event broker (100) as eXtensible Markup Language (‘XML’) message documents transmitted using the HyperText Transfer Protocol (‘HTTP’). Other message formats for passing requests and responses between a client (140, 142, 144, or 146) and the event broker (100) may include the Java Application Programming Interface for XML-based Remote Procedure Calls (‘JAX-RPC’), XML-Remote Procedure Calls (‘XML-RPC’), or any other messaging format as will occur to those of skill in the art. Other protocols useful for transmitting messages between a client (140, 142, 144, or 146) and the event broker (100) include the File Transfer Protocol (° FTP’), Simple Mail Transfer Protocol (‘SMTP’), eXtensible Messaging and Presence Protocol (‘XMPP’), DMTF CIM Operations Over HTTP, and any other protocols as will occur to those of skill in the art.

In the example system of FIG. 1, each device (110-116, 130, 132, 134, and 136) connects for data communications to network (101). Server (110) connects to network (101) through wireline connection (105). Router (112) connects to network (101) through wireline connection (106). Blade chassis (114) connects to network (101) through wireline connection (107). Workstation (116) connects to network (101) through wireline connection (108). Laptop (130) connects to network (101) through wireless connection (137). Network enabled mobile phone (132) connects to network (101) through wireless connection (138). Personal Digital Assistant (‘PDA’) (134) connects to network (101) through wireless connection (139). Server (136) connects to network (101) through wireline connection (109).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

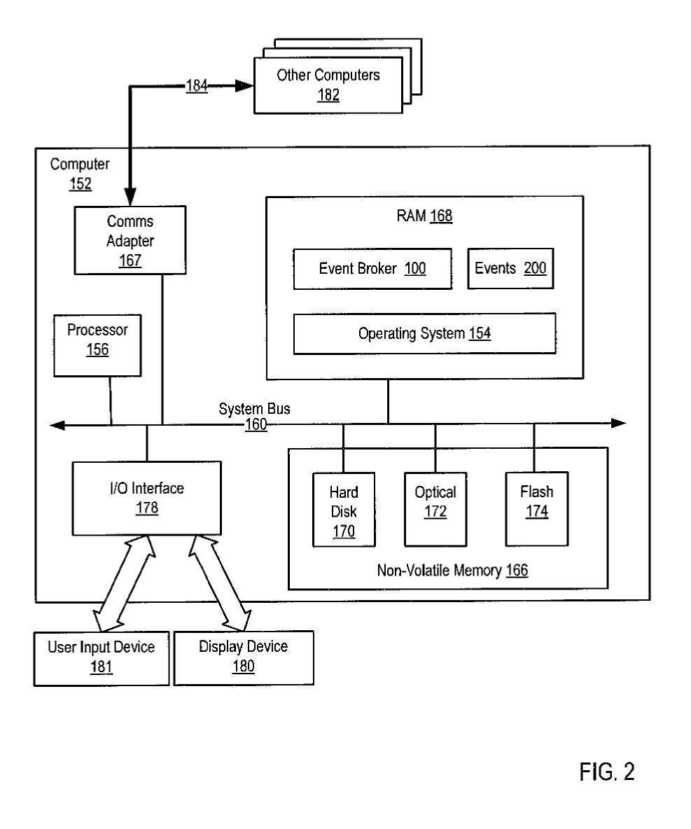

Enumerating events for a client in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in enumerating events for a client according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is an event broker (100), a set of computer program instructions improved for enumerating events (200) for a client according to embodiments of the present invention. The events (200) represent changes in the state of a computing environment or in the behavior of some component of the computing environment occurring in a request time period. The event broker (100) operates generally to enumerate events (200) for a client according to embodiments of the present invention by receiving from one or more clients a request for events occurring in a requested time period, retrieving from an event provider the requested events occurring in the requested time period, and providing in response to the one or more clients one or more of the retrieved events.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), event broker (100), and events (200) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as the Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful for enumerating events for a client according to embodiments of the present invention include modems for wired dial-up communications, Ethernet (IEEE 802.3) adapters for wired network communications, and 802.11b adapters for wireless network communications.

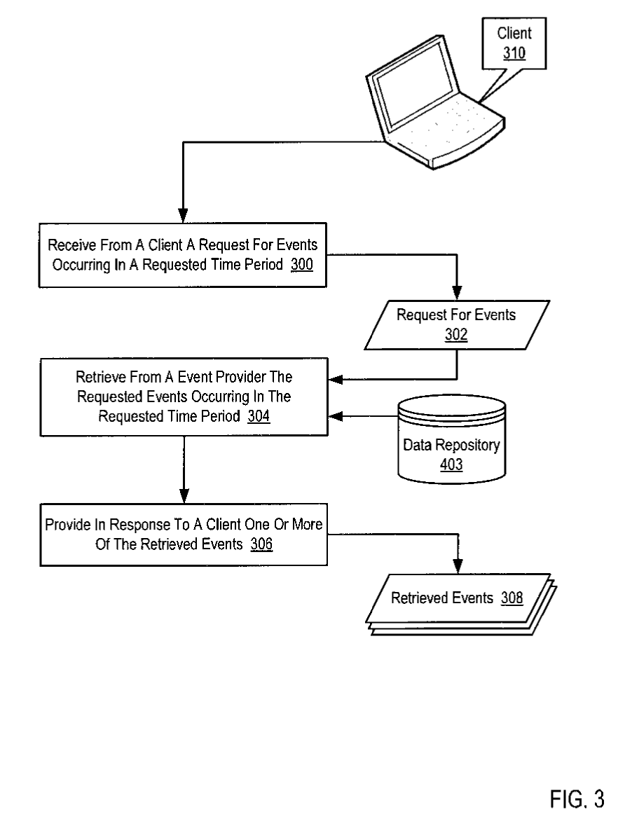

For further explanation, FIG. 3 sets forth a flow chart illustrating an exemplary method for enumerating events for a client according to embodiments of the present invention. The example method of FIG. 3 includes receiving (300) from a client (310) a request (302) for events occurring in a requested time period. The request (302) for events occurring in a requested time period represents a client's request for information regarding the changes in the state of a computing environment or in the behavior of some component of the environment occurring in a requested time period. In the method of FIG. 3, receiving (300) from one or more clients a request (302) for events occurring in a requested time period may be carried out by receiving an XML document containing the requested time period sent by a client through a client interface API. Consider for further explanation, the following exemplary function for requesting events occurring in a requested time period in an exemplary client interface API:
eventsList clientEnumerateEvents(time beginTimeStamp, time endTimeStamp);

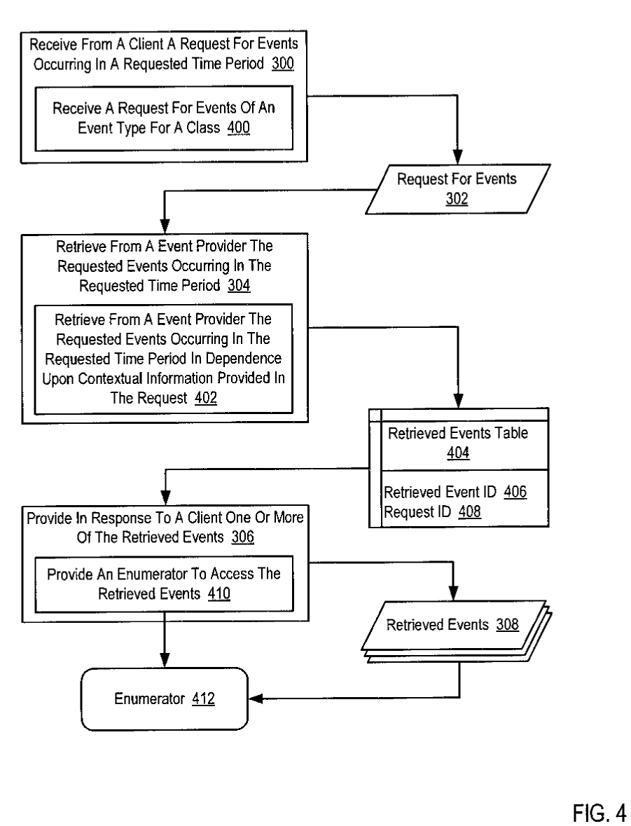

This example function creates a request (302) for events occurring in a requested time period that begins at a time specified by the value of ‘beginTimeStamp’ and ends at a time specified by the value of ‘endTimeStamp.’ The ‘clientEnumerateEvents’ function returns to the client a list of events occurring in the requested time period. Although the example function above returns a list of event occurring in the requested time period, the example ‘clientEnumerateEvents’ function may return other data structures such as, for example, an enumerator for accessing the retrieved events (308) as discussed below with reference to FIG. 4. An enumerator is a software interface for traversing the events in an event provider.

In the method of FIG. 3, receiving (300) from a client a request (302) for events occurring in a requested time period may also be carried out by receiving the request (302) for events of an event type for a class, determining a valid time period in dependence upon the requested time period, or determining a valid time period in dependence upon an end time of the requested time period of a previous request for events as discussed below with reference to FIGS. 4, 5, and 6. Receiving the request (302) for events of an event type for a class, determining a valid time period in dependence upon the requested time period, or determining a valid time period in dependence upon an end time of the requested time period of a previous request for events advantageously operates to enumerate particular types of events occurring in a particular time period for client (310).

The example method of FIG. 3 also includes retrieving (304) from an event provider the requested events occurring in the requested time period. Retrieving (304) from an event provider the requested events occurring in the requested time period may be carried out by loading and initializing an event provider that implements a provider interface API used to retrieve events that represent a change in state or behavior of a component in a computing environment if the event provider is not already loaded. Loading and initializing an event provider that implements a provider interface API used to retrieve events that represent a change in state or behavior of a component in a computing environment may be carried out by retrieving the event provider from a data repository (403).

In the method of FIG. 3, retrieving (304) from an event provider the requested events occurring in the requested time period may further be carried out by utilizing a provider interface API. Consider for further explanation, the following exemplary function for retrieving (304) from an event provider the requested events occurring in the requested time period:
eventsList providerEnumerateEvents(time beginTimeStamp, time endTimeStamp);

This example function retrieves (304) from an event provider the requested events occurring in a requested time period that begins at a time specified by the value of ‘beginTimeStamp’ and ends at a time specified by the value of ‘endTimeStamp.’ The ‘providerEnumerateEvents’ function returns from an event provider a list of events occurring in the requested time period. Although the example function above returns a list of event occurring in the requested time period, the example ‘providerEnumerateEvents’ function may return other data structures such as, for example, an enumerator for accessing the events in an event provider as discussed below with reference to FIG. 4.

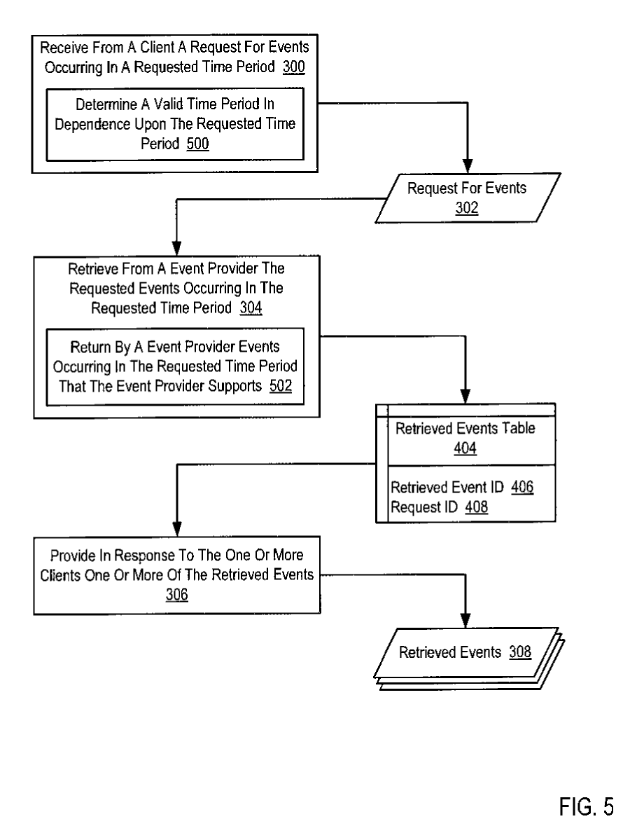

In the method of FIG. 3, retrieving (304) from an event provider the requested events occurring in the requested time period according to the method of FIG. 3 may also be carried out by retrieving from the event provider the requested events occurring in the requested time period in dependence upon contextual information provided in the request, or by returning by an event provider events occurring in the requested time period that the event provider supports as discussed below with reference to FIGS. 4 and 5. Retrieving from the event provider the requested events occurring in the requested time period in dependence upon contextual information provided in the request, or by returning by an event provider events occurring in the requested time period that the event provider supports advantageously operates to enumerate events for a client according to the operating characteristics of the event provider.

The example method of FIG. 3 also includes providing (306) in response to the client one or more of the retrieved events (308). Retrieved events (308) represent the events returned from an event provider. Providing (306) in response to the one or more clients one or more of the retrieved events (308) according to the method of FIG. 3 may be carried out by transmitting an XML document containing one or more of the retrieved events (308) to a client as the return from the client's call to a function of a client interface API such as, for example, the ‘clientEnumerateEvents’ function above.

In the example of FIG. 3, providing (306) in response to the client one or more of the retrieved events (308) according to the method of FIG. 3 may also be carried out by providing an enumerator to access the retrieved events as discussed below with reference to FIG. 4. Providing an enumerator to access the retrieved events advantageously operates to enumerate events for a client by allowing the client to access the retrieved events one at a time.

As discussed above, receiving from one or more clients a request for events occurring in a requested time period may be carried out by receiving an XML document containing the requested time period sent by a client through a client interface API. Readers will note that the example function of a client interface API described above with reference to FIG. 3 does not distinguish between the type of event or the component for which the event represents a change in state or behavior. The example function above, therefore, returns all of the events occurring in a requested time period without regard to type of event or the component for which the event represents a change in state or behavior. A client, however, may request a set of events occurring in a requested time period relating to a particular type of event or component for which the events represent a change in state or behavior. For further explanation, therefore, FIG. 4 sets forth a flow chart illustrating another exemplary method for enumerating events for a client according to embodiments of the present invention that includes receiving (400) the request (302) for events of an event type for a class

The method of FIG. 4 is similar to the method of FIG. 3 in that the method of FIG. 4 also includes receiving (300) from one or more clients a request (302) for events occurring in a requested time period, retrieving (304) from an event provider the requested events occurring in the requested time period, and providing (306) in response to the one or more clients one or more of the retrieved events (308). In the method of FIG. 4, receiving (300) from one or more clients a request (302) for events occurring in a requested time period includes receiving (400) the request (302) for events of an event type for a class. A class represents a component in a computing environment for which events represent a change in state or behavior. For example, a class may represent a disk drive, a file, a router, a computer software application, a block of memory, a power supply, a server, and so on. An event type represents the kind of change in the state of a computing environment or in the behavior of some component of the environment. For example, an event type may represent the changes to the power supply of a disk drive, the changes to the software installed on a computer, the changes to server blades installed in a blade server chassis, and so on. Examples of events of an event type therefore may represent the power of a particular disk drive dropping below a threshold, a particular software application installing on a computer, an insertion of a particular server blade into a blade server chassis, and so on.

In the example of FIG. 4, receiving (400) the request (302) for events of an event type for a class may be carried out by receiving an XML document containing the requested time period, the event type, and the class sent by a client through a client interface API. Consider for further explanation, the following exemplary function for requesting events occurring in a requested time period of an event type for a class:
eventsList clientEnumerateEvents(eventType eType, className cName, time beginTimeStamp, time endTimeStamp);

This example function creates a request (302) for events of an event type specified by the value of ‘eType,’ for events representing a change in state or behavior of a component represented by the class specified by the value of ‘cName,’ and events occurring in a requested time period that begins at a time specified by the value of ‘beginTimeStamp’ and ends at a time specified by the value of ‘endTimeStamp.’ The ‘clientEnumerateEvents’ function returns to the client a list of events occurring in the requested time period.

When requesting events for a component in a computing environment, a client often does not know how the particular component is implemented. For example, a client may request events for the disk drives on a particular machine without knowing whether the drives are implemented as SCSI drives, IDE drives, external USB drives, and so on. Because a component may be implemented in a variety of ways, a client may request a set of events occurring in a requested time period for all implementations of the component in a computing environment. In the method of FIG. 4, therefore, receiving (300) from one or more clients a request (302) for events occurring in a requested time period may be carried out by receiving the request for events for a class and a subclass of the class. The class represents the component for which a client requests events. The subclass is derived from the class and represents implementations of the component represented by the class. Continuing with the example from above, a class may represent a disk drive generally, while the subclass of the class may represent the specific implementations of the disk drive such as a SCSI drive, an IDE drive, or an external USB drive.

In the method of FIG. 4, receiving the request for events for a class and a subclass of the class may be carried out by receiving an XML document containing the requested time period, the event type, the class, and an indication to include events for the subclasses of the class sent by a client through a client interface API. Consider for further explanation, the following exemplary function for requesting events occurring in a requested time period of an event type for a class:
eventsList clientEnumerateEvents(eventType eType, className cName, boolean deepInheritance, time beginTimeStamp, time endTimeStamp);

When the value specified by ‘deepInheritance’ represents ‘TRUE,’ this example function above creates a request (302) for events of an event type specified by the value of ‘eType,’ for events representing a change in state or behavior of a component and any implementations of the component represented by the class specified by the value of ‘cName,’ and events occurring in a requested time period that begins at a time specified by the value of ‘beginTimeStamp’ and ends at a time specified by the value of ‘endTimeStamp.’ When the value specified by ‘deepInheritance’ represents ‘FALSE,’ this example function creates a request (302) for events of an event type specified by the value of ‘eType,’ for events representing a change in state or behavior of only the component represented by the class specified by the value of ‘cName,’ and events occurring in a requested time period that begins at a time specified by the value of ‘beginTimeStamp’ and ends at a time specified by the value of ‘endTimeStamp.’ The ‘clientEnumerateEvents’ function returns to the client a list of events occurring in the requested time period.

The method of FIG. 4 also includes retrieving (304) from an event provider the requested events occurring in the requested time period. When a client requests a set of events occurring in a requested time period relating to a component and any implementations of the component using the ‘deepInheritance’ parameter of a client interface API as explained above, retrieving (304) from an event provider the requested events occurring in the requested time period may be carried out by iteratively utilizing a provider interface API as discussed above with reference to FIG. 3.

As discussed above, retrieving from an event provider the requested events occurring in the requested time period may be carried out by retrieving from the event provider the requested events occurring in the requested time period in dependence upon contextual information provided in the request. In the method of FIG. 4, therefore retrieving (304) from an event provider the requested events occurring in the requested time period includes retrieving (402) from the event provider the requested events occurring in the requested time period in dependence upon contextual information provided in the request (302). Contextual information represents attributes of a request (302) recognized by a specific event provider. For example, contextual information may represent that the request (302) for events occurring in a requested time period that have a ‘net’ change in the state or behavior of a component for which events represent a change in state or behavior. Such contextual information may be useful when a client is only interested in events representing the creation or deletion of files during a requested time period, but not the creation and deletion of the same file during the requested time period. A client may provide contextual information in a request through a ‘context’ parameter in a function of a client interface API such as, for example, the ‘clientEnumerateEvents( )’ function above. A value of ‘0’ for the ‘context’ parameter may indicate that a client requests each event occurring in a requested time period representing a change in the state or behavior of a component, a value of ‘1’ for the ‘context’ parameter may indicate that a client requests that the event provider combine two or more events into one event when the two or more events do not have a net change in the state or behavior of a component, a value of ‘2’ for the ‘context’ parameter may indicate that a client requests only events occurring in a requested time period that have a ‘net’ change in the state or behavior of a component.

When a client provides the contextual information in a request, retrieving (402) from the event provider the requested events occurring in the requested time period in dependence upon contextual information provided in the request (302) according to the method of FIG. 4 may be carried out by using a provider interface API. Consider for further explanation, the following exemplary function for requesting events occurring in a requested time period in dependence upon contextual information provided in the request:
eventsList providerEnumerateEvents(eventType eType, className cName, time beginTimeStamp, time endTimeStamp, hashTable context);

This example function retrieves events of an event type specified by the value of ‘eType,’ for events representing a change in state or behavior of a component represented by the class specified by the value of ‘cName,’ and events occurring in a requested time period that begins at a time specified by the value of ‘beginTimeStamp’ and ends at a time specified by the value of ‘endTimeStamp.’ The ‘providerEnumerateEvents’ function retrieves from an event provider a list of events occurring in the requested time period in dependence upon contextual information specified by the value of ‘context.’ In the example function above, a client specifies the value of ‘context’ using a hash table of key/value pairs.

In the method of FIG. 4, retrieving (304) from an event provider the requested events occurring in the requested time period may further be carried out by storing the retrieved events in a retrieved events table (404). The retrieved events table (404) associates a retrieved event identifier (406) with a request identifier (408). The retrieved event identifier (406) represents a single event retrieved from an event provider. The request identifier (408) represents a single request from a client. Although in the example of FIG. 4, retrieving (304) from an event provider the requested events occurring in the requested time period may be carried out by storing the retrieved events in a retrieved events table (404), storing the retrieved events in a retrieved events table (404) is explanation and not for limitation. In fact, retrieving (304) from an event provider the requested events occurring in the requested time period may also be carried out by receiving an enumerator from an event provider or by any other method as will occur to those of skill in the art.

Readers will notice that each of the example ‘clientEnumerateEvents’ functions above returns a list of one or more of the retrieved events (308) to a client. As mentioned above, the example ‘clientEnumerateEvents’ function may return other data structures such as, for example, an enumerator for accessing the events in an event provider. In the method of FIG. 4, therefore, providing (306) in response to the one or more clients one or more of the retrieved events (308) includes providing (410) an enumerator (412) to access the retrieved events (308). An enumerator (412) represents a software interface provided to the client that allows the client to traverse the retrieved events (308) retrieved from an event provider. An example of an enumerator (412) useful in enumerating events for a client according to embodiments of the present invention may include the ‘java.util.Enumeration’ interface provided in the Java™ 2.0 Software Development Kit that includes the following functions:
boolean hasMoreElements( ), tests if this enumeration contains more elements.
Object nextElement( ), returns the next element of this enumeration if this enumeration object has at least one more element to provide.

Through enumerator (412), providing (306) in response to the one or more clients one or more of the retrieved events (308) may be carried out by providing to a client a range of retrieved events (308). Consider, for example, that 1000 events are retrieved in response to a client's request for events occurring in a requested time period. Providing (306) in response to the one or more clients one or more of the retrieved events (308) according to the method of FIG. 4, may be carried out by providing only the first fifty events to the client.

As discussed above, receiving from one or more clients a request for events occurring in a requested time period may be carried out by determining a valid time period in dependence upon the requested time period. For further explanation, therefore, FIG. 5 sets forth a flow chart illustrating another exemplary method for enumerating events for a client according to embodiments of the present invention that includes determining (500) a valid time period in dependence upon the requested time period. The method of FIG. 5 is similar to the method of FIG. 3 in that the method of FIG. 5 also includes receiving (300) from one or more clients a request (302) for events occurring in a requested time period, retrieving (304) from an event provider the requested events occurring in the requested time period, and providing (306) in response to the one or more clients one or more of the retrieved events (308).

Readers will recall that receiving (300) from one or more clients a request (302) for events occurring in a requested time period may be carried out by receiving the request for the requested time period sent by a client using an exemplary function of a client interface API such as:
eventsenumerator clientEnumerateEvents(time beginTimeStamp, time endTimeStamp);

This example function creates a request (302) for events occurring in a requested time period that begins at a time specified by the value of ‘beginTimeStamp’ and ends at a time specified by the value of ‘endTimeStamp.’ The ‘clientEnumerateEvents’ function returns to the client an eventsenumerator object to access the retrieved events occurring in the requested time period.

When a client uses the example ‘clientEnumerateEvents’ function from above to provide the request (302) for events occurring in a requested time period, the client may specify a value for the ‘endTimeStamp’ parameter that occurs in the future or not specify a value for the ‘endTimeStamp’ parameter at all. In the method of FIG. 5, therefore, receiving (300) from one or more clients a request (302) for events occurring in a requested time period includes determining (500) a valid time period in dependence upon the requested time period. A valid time is a period having begin and end times that fall within predetermined parameters. For example, a valid time period may be defined as a time period representing a time period having an end time that does not occur in the future, a time period less than one hundred years, a time period with a begin time that occurs within the past year, and so on.

When a client specifies a value for the ‘endTimeStamp’ parameter that occurs in the future, determining (500) a valid time period in dependence upon the requested time period according to the example of FIG. 5 may be carried out by setting a new value for the ‘endTimeStamp’ parameter to the current time. The current time may be obtained by using a function call to an operating system API such as, for example, Win32's ‘GetTime( )’ function, and UNIX's ‘gettimeofday( )’ function. When a client does not specify a value for the ‘endTimeStamp’ parameter at all, determining (500) a valid time period in dependence upon the requested time period according to the example of FIG. 5 may also be carried out by setting a new value for the ‘endTimeStamp’ parameter to the current time.

Readers will note that, in addition to omitting the ‘endTimeStamp,’ a client may not specify the ‘beginTimeStamp’ when using the example ‘clientEnumerateEvents’ function from above to provide the request (302) for events occurring in a requested time period. An unspecified value for the ‘beginTimeStamp’ parameter of the ‘clientEnumerateEvents’ function may imply that a requested time period of a request (302) begins with the earliest available event representing a change in state or behavior of a component in a computing environment.

Although a client may not omit a value for the ‘beginTimeStamp’ parameter when using the example ‘clientEnumerateEvents’ function from above to provide the request (302) for events occurring in a requested time period, a client may specify a value for the ‘beginTimeStamp’ parameter that an event provider does not support. For example, a client may request events occurring from 12:01 am on Jan. 1, 1880 to the current time when an event provider only supports providing events occurring from 12:01 am on Jan. 1, 2001 to the current time. In the example of FIG. 5, therefore, retrieving (304) from an event provider the requested events occurring in the requested time period includes returning (502) by an event provider events occurring in the requested time period that the event provider supports. Returning (502) by an event provider events occurring in the requested time period that the event provider supports may be carried out by storing the retrieved events in a retrieved events table (404). As mentioned above, the retrieved events table (404) associates a retrieved event identifier (406) with a request identifier (408). The retrieved event identifier (406) represents a single event retrieved from an event provider. The request identifier (408) represents a single request from a client.

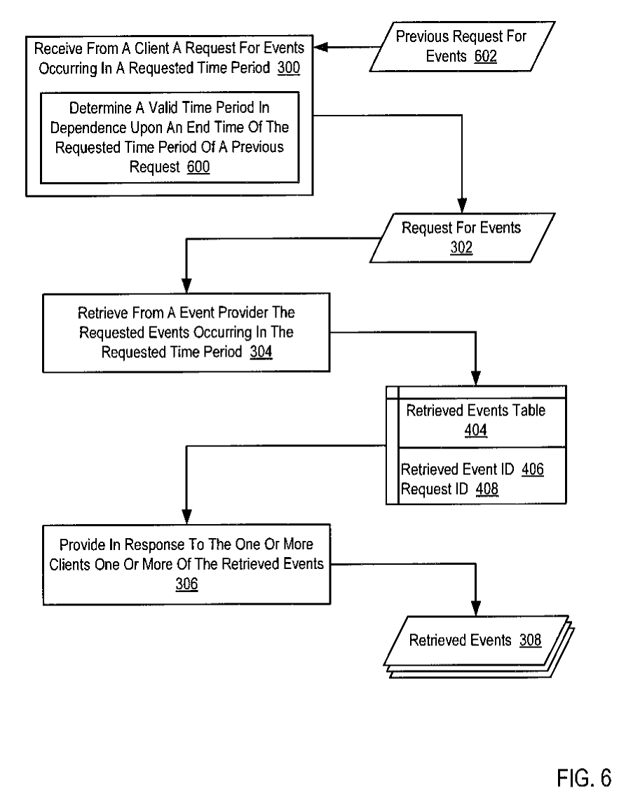

As discussed above with reference to FIG. 3, receiving from one or more clients a request for events occurring in a requested time period may be carried out by determining a valid time period in dependence upon an end time of the requested time period of a previous request for events. For further explanation, therefore, FIG. 6 sets forth a flow chart illustrating another exemplary method for enumerating events for a client according to embodiments of the present invention that includes determining (600) a valid time period in dependence upon an end time of the requested time period of a previous request for events (602). The method of FIG. 6 is similar to the method of FIG. 3 in that the method of FIG. 6 also includes receiving (300) from one or more clients a request (302) for events occurring in a requested time period, retrieving (304) from an event provider the requested events occurring in the requested time period, and providing (306) in response to the one or more clients one or more of the retrieved events (308).

Because a client may seek to obtain events occurring over a long period of time that may include time in the future, a client may obtain the events using multiple requests (302). The requested time period for each subsequent request for events may be for a time period immediately after the time period of the previous request. Consider, for example, that the current time is 6:00 pm. At 3:00 pm, a client may have requested events occurring from noon to 3:00 pm in a previous request and may now request events occurring from 3:00 pm to 6:00 pm. In the method of FIG. 6, therefore, receiving (300) from one or more clients a request (302) for events occurring in a requested time period may be carried out by determining (600) a valid time period in dependence upon an end time of the requested time period of a previous request (602) for events. The valid time period represents a time period having an end time that does not occur in the future and a begin time equal to the end time of the requested time period of the previous request. The previous request (602) for events represents a request for events that a client requested before the current request (302) for events.

In the method of FIG. 6, determining (600) a valid time period in dependence upon an end time of the requested time period of a previous request for events (602) may be carried out by setting in a client a value for the ‘beginTimeStamp’ parameter of the current request (302) for events as the value of the ‘endTimeStamp’ parameter of the previous request (602) for events. A client may obtain the value for the ‘endTimeStamp’ parameter of the previous request (602) for events using functions of an enumerator provided to the client as discussed above with reference to FIG. 4. An enumerator represents a software interface provided to the client that allows the client to traverse the retrieved events (308) retrieved from an event provider. An example of an enumerator useful in enumerating events for a client according to embodiments of the present invention may include an extended version of the ‘java.util.Enumeration’ interface provided in the Java™2.0 Software Development Kit having the following exemplary extended functions:
time getBeginTime( ), returns the begin time of the requested time period of the retrieved events (308) from the event provider.
time getEndTime( ), returns the end time of the requested time period of the retrieved events (308) from the event provider.

In the method of FIG. 6, retrieving (304) from an event provider the requested events occurring in the requested time period may be carried out by storing the retrieved events in a retrieved events table (404). The retrieved events table (404) associates a retrieved event identifier (406) with a request identifier (408). The retrieved event identifier (406) represents a single event retrieved from an event provider. The request identifier (408) represents a single request from a client. Although in the example of FIG. 6, retrieving (304) from an event provider the requested events occurring in the requested time period may be carried out by storing the retrieved events in a retrieved events table (404), storing the retrieved events in a retrieved events table (404) is explanation and not for limitation. In fact, retrieving (304) from an event provider the requested events occurring in the requested time period may also be carried out by receiving an enumerator from an event provider or by any other method as will occur to those of skill in the art.

The method of FIG. 6 includes providing (306) in response to the one or more clients one or more of the retrieved events (308). Retrieved events (308) represent the events returned from an event provider. Providing (306) in response to the one or more clients one or more of the retrieved events (308) may be carried out as described above with reference to FIG. 4.

Exemplary embodiments of the present invention are described largely in the context of a fully functional computer system for enumerating events for a client. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for enumerating events for a client, the method comprising:
receiving from one or more clients a request for events occurring in a requested time period;
wherein the requested time period has a begin time other than the current time;
retrieving from an event provider the requested events occurring in the requested time period; and
providing in response to the one or more clients one or more of the retrieved events.

2. The method of claim 1 wherein receiving from the one or more clients the request for events occurring in the requested time period further comprises receiving the request for events of an event type for a class.

3. The method of claim 1 wherein retrieving from the event provider the requested events occurring in the requested time period further comprises retrieving from the event provider the requested events occurring in the requested time period in dependence upon contextual information provided in the request.

4. The method of claim 1 wherein providing in response to the one or more clients one or more of the retrieved events further comprises providing an enumerator to access the retrieved events.

5. The method of claim 1 wherein receiving from the one or more clients the request for events occurring in the requested time period further comprises determining a valid time period in dependence upon the requested time period.

6. The method of claim 1 wherein receiving from the one or more clients the request for events occurring in the requested time further comprises determining a valid time period in dependence upon an end time of the requested time period of a previous request for events.

7. The method of claim 1 wherein retrieving from the event provider the requested events occurring in the requested time period further comprises returning by an event provider events occurring in the requested time period that the event provider supports.

8. An apparatus for enumerating events for a client, the apparatus comprising a computer processor, a computer memory operatively coupled to the computer processor, the computer memory having disposed within it computer program instructions capable of:
receiving from one or more clients a request for events occurring in a requested time period;
wherein the requested time period has a begin time other than the current time;
retrieving from an event provider the requested events occurring in the requested time period; and
providing in response to the one or more clients one or more of the retrieved events.

9. The apparatus of claim 8 wherein receiving from the one or more clients the request for events occurring in the requested time period further comprises receiving the request for events of an event type for a class.

10. The apparatus of claim 8 wherein retrieving from the event provider the requested events occurring in the requested time period further comprises retrieving from the event provider the requested events occurring in the requested time period in dependence upon contextual information provided in the request.

11. The apparatus of claim 8 wherein providing in response to the one or more clients one or more of the retrieved events further comprises providing an enumerator to access the retrieved events.

12. The apparatus of claim 8 wherein receiving from the one or more clients the request for events occurring in the requested time period further comprises determining a valid time period in dependence upon the requested time period.

13. A computer program product for enumerating events for a client, the computer program product disposed upon a signal bearing medium, the computer program product comprising computer program instructions capable of:
receiving from one or more clients a request for events occurring in a requested time period;
wherein the requested time period has a begin time other than the current time;
retrieving from an event provider the requested events occurring in the requested time period; and
providing in response to the one or more clients one or more of the retrieved events.

14. The computer program product of claim 13 wherein the signal bearing medium comprises a recordable medium.

15. The computer program product of claim 13 wherein the signal bearing medium comprises a transmission medium.

16. The computer program product of claim 13 wherein receiving from the one or more clients the request for events occurring in the requested time period further comprises receiving the request for events of an event type for a class.

17. The computer program product of claim 13 wherein retrieving from the event provider the requested events occurring in the requested time period further comprises retrieving from the event provider the requested events occurring in the requested time period in dependence upon contextual information provided in the request.

18. The computer program product of claim 13 wherein providing in response to the one or more clients one or more of the retrieved events further comprises providing an enumerator to access the retrieved events.

19. The computer program product of claim 13 wherein receiving from the one or more clients the request for events occurring in the requested time period further comprises determining a valid time period in dependence upon the requested time period.

20. The computer program product of claim 13 wherein receiving from the one or more clients the request for events occurring in the requested time further comprises determining a valid time period in dependence upon an end time of the requested time period of a previous request for events.
